(19) United States
(12) Patent Application Publication
(10) Pub. No.: US 2008/0034764 A1
(43) Pub. Date: Feb. 14, 2008

(54) Air conditioner for a vehicle and controlling method thereof

(75) Inventor: Masami Iwasaki, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariay-city (JP)

(21) Appl. No.: 11/890,710

(22) Filed: Aug. 7, 2007

(30) Foreign Application Priority Data
Aug. 11, 2006 (JP) 2006-219996

(51) Int. Cl. B60H 1/00

(52) U.S. Cl. 62/159; 237/2 A

(57) ABSTRACT

An object of the present invention is to provide an air conditioner and a controlling method thereof capable of effectively conditioning air in an operator cab of a vehicle even if a windshield or door of the operator cab is opened. The air conditioner comprises: a heating unit for heating an upper half of an operator's body; an open/close sensor for detecting opening and closing of the operator cab; and a controller for setting a heating power of the heating unit when the open/close sensor detects that the operator cab is opened, to be higher than the heating power of the heating unit when the operator cab is closed.

The applicant claims the right of priority based on Japanese Patent Application JP 2006-219996, filed on Aug. 11, 2006, and the entire content of JP-2006-219996 is hereby incorporated by reference.

### FIELD OF THE INVENTION

The present invention relates to an air conditioner for a vehicle and a controlling method thereof. More particularly, the present invention relates to an air conditioner for a construction vehicle and a controlling method thereof.

### BACKGROUND OF THE INVENTION

Recently, even on a construction vehicle such as a power shovel, an air conditioner is mounted so that the operator cab can be maintained in a comfortable state. However, sometimes, the operator operates the construction vehicle, while a windshield or an entrance door of the operator cab is kept open, in order for the operator to communicate with a worker that is working outside the operator cab or in order for the operator to ensure a good field of vision. When the operator operates the construction vehicle while the windshield or the door is kept open, a large volume of outside air enters into the operator cab. Accordingly, it is impossible for the air conditioner to effectively condition air in the operator cab. Therefore, it is difficult to maintain the operator cab in a comfortable state.

In order to solve the above problems, Japanese patent application JP-A-2000-052742 by Asami et al. discloses an air conditioner for a construction vehicle, which enhances the cooling or the heating power thereof. When a sensor detects that the windshield or door is open, the air conditioner cools or heats according to its maximum capacity, and increases the volume of air blown out from a front face blowout port or a spot blowout port in order to blow conditioned air around the operator's seat. Due to the foregoing, it is possible to provide a comfortable cooling or heating state by the air conditioner without changing its setting.

However, when the operator opens the windshield or the door in order to ensure a good field of vision, the windshield or the door has to be fully opened in many cases. Therefore, when the windshield is open, even when the air conditioning capacity is simply enhanced so as to increase the volume of conditioned air to be blown out, most of the conditioned air immediately flows outside the operator cab. Accordingly, the effect of air conditioning cannot be improved much. On the contrary, the operational noise of the air conditioner is increased, which makes the operator feel uncomfortable.

### SUMMARY OF THE INVENTION

An object of the present invention is to provide an air conditioner and a controlling method thereof capable of effectively conditioning air in an operator cab of a vehicle even if a windshield or door of the operator cab is opened.

According to one aspect of the present invention, an air conditioner for conditioning air in an operator cab of a vehicle is provided. The air conditioner comprises: a heating unit for heating the upper half of the body of the operator; an open/close sensor for detecting that the operator cab is opened or closed; and a controller for setting a heating power of the heating unit in the case where the open/close sensor detects that the operator cab is opened, to be higher than the heating power of the heating unit when the operator cab is closed. Due to the above constitution, while the operator cab is opened, the air conditioner intensively heats the upper half of the operator's body, ant thus, can effectively execute air-conditioning in the operator cab.

It is preferable that the heating unit comprises a front face heating unit for heating a front face of the operator. It is preferable that the controller sets a heating power of the front face heating unit when the open/close sensor detects that the operator is opened, to be higher than that when the operator cab is closed.

According to another aspect of the present invention, an air conditioner for conditioning air in an operator cab of a vehicle is provided. The air conditioner comprises: an air conditioning unit for generating conditioned air; at least a first blowout port for blowing out conditioned air, toward the upper half of the operator's body; a second blowout port for blowing the conditioned air; an open/close sensor for detecting whether the operator cab is opened or closed; and a controller for setting a ratio of volume of the conditioned air, which is blown out from the first blowout port in the conditioned air, which is blown out from each blowout port when the open/close sensor detects that the operator cab is opened, to be higher than the ratio of conditioned air when the operator cab is closed. Due to the above constitution, while the operator cab is opened, the conditioned air is concentrated on the periphery of the upper half of the operator's body. Therefore, the air conditioner can effectively execute air-conditioning in the operator cab.

It is preferable that the conditioned air is heated.

It is preferable that the above air conditioner is used for a construction vehicle.

It is preferable that the at least one first blowout port comprises a face blowout port for blowing out conditioned air to a front side of the operator. It is preferable that the controller sets the ratio of conditioned air which is blown out from the face blowout port in the conditioned air which is blown out from each blowout port, when the open/close sensor detects that the operator cab is opened to be higher than the ratio of conditioned air when the operator cab is closed. According to this constitution, the air conditioner increase a volume of air blown out to the face of the operator, which easily feels an effect of air conditioning. Therefore, the operator can feel more comfortable.

Further, it is preferable that the second blowout port is a blowout port arranged at the rear of a operator's seat. It is preferable that when the open/close sensor detects that the operator cab is opened, the controller sets the ratio of volume of the conditioned air so that the conditioned air is blown out from both the first blowout port and the second blowout port, and when the open/close sensor detects that the operator cab is closed, the controller sets the ratio of volume of the conditioned air so that the conditioned air is blown out only from the second blowout port.

Preferably, the air conditioner further comprises a temperature sensor for measuring a temperature of air in the operator cab or a temperature of air out the operator cab, and when the open/close sensor detects that the operator cab is opened and the measured outside air temperature or the measured inside air temperature is not higher than a predetermined temperature, the controller sets the ratio of volume of the conditioned air to be higher than the ratio of volume of the conditioned air when the operator cab is closed. By referring to the temperature of the outside air or the inside air, the air conditioner can only increase the volume of the conditioned air which is blown out from the first blowout port, in a cold season. Therefore, it is possible to prevent heating the operator cab too much.

It is preferable that the above air conditioner is used for a construction vehicle. The construction vehicle is usually a one-operator vehicle. Therefore, the operator cab of the construction vehicle is small. Accordingly, when the operator cab is opened, the temperature in the operator cab is remarkably changed. Therefore, by applying the air conditioner of the present invention to the construction vehicle, the air conditioning effect can be greatly improved while the operator cab is opened.

According to still another aspect of the present invention, the present invention provides a control method of an air conditioner for conditioning air in an operator cab of a vehicle, the air conditioner comprising a heating unit for heating the upper half of the operator's body working in the operator cab. The control method comprises detecting whether the operator cab is opened or closed, and setting the heating power of the heating unit when it is detected that the operator cab is opened, to be higher than the heating power when it is detected that the operator cab is closed.

According to still another aspect of the present invention, the present invention provides a control method of controlling an air conditioner for conditioning air in an operator cab of a vehicle, the air conditioner comprising an air conditioning unit for generating conditioned air, at least one first blowout port for blowing conditioned air to the upper half of the operator's body and a second blowout port for blowing the conditioner air. The control method comprises: detecting whether the operator cab is opened or closed and setting a ratio of volume of the conditioned air which blown out from the first blowout port when it is detected that the operator cab is opened, to be higher than the ratio of volume of the conditioned air when it is detected that the operator cab is closed.

### DESCRIPTION OF THE DRAWINGS

These and other features and advantages of the present invention will be better understood by reading the following detailed description, taken together with the drawings wherein:

FIG. 1 shows an arrangement view of an operator cab of a vehicle having an air conditioner according to the present invention;

FIG. 2 shows an overall arrangement view of an air conditioner according to the present invention;

FIG. 3 shows a functional block diagram of a controller of an air conditioner;

FIG. 4 shows a flow chart of a control operation of an air conditioner according to the present invention; and

FIG. 5 shows a flow chart of an air volume ratio adjusting operation of an air conditioner according to the present invention.

### DETAILED DESCRIPTION OF THE PREFERRED EMBODIMENT

Referring to the drawings, an air conditioner according to one embodiment of the present invention will be explained below. However, it should be noted that the present invention is not limited by the following explanations. Variations may be made without departing from the scope of the claim of the present invention.

The air conditioner according to the present invention, changes a ratio of volume of the conditioned air blown out from each blowout port and concentrates the conditioned air on the periphery of the upper half of the operator's body, when it is detected that a windshield or an entrance door are opened. Therefore, even if the operator works in the operator cab while the operator cab is opened, the air conditioner can perform effectively air conditioning.

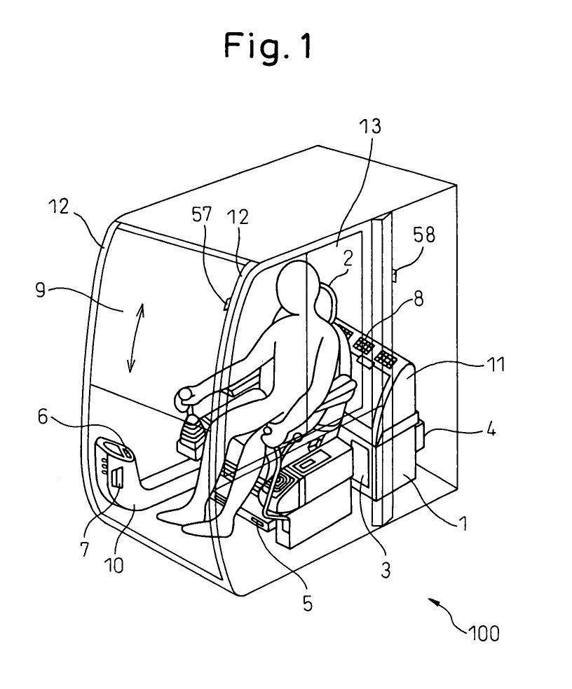

FIG. 1 shows an arrangement view of an outline of an operator cab 100 of a construction vehicle having an air conditioner 1 according to the present invention.

As shown in FIG. 1, a seat 2 for an operator is arranged in the operator cab 100. In a rear lower portion of the seat, an air conditioner 1 is arranged. The air conditioner 1 takes in air from the operator cab 100 through an inside air suction port 3, which is arranged close to the air conditioner 1 and provided with an opening directed toward the operator cab 100. In the same manner, the air conditioner 1 takes in air from the outside of the operator cab 100 through an outside air suction port 4, which is provided with an opening directed outside of the operator cab 100. The air conditioner 1 heats or cools air taken in through the inside air suction port 3 or the outside air suction port 4. A foot blowout port (FOOT) 5 arranged in a portion close to the foot of the operator, a face blowout port (FACE) 6 arranged close to a windshield 9 and open toward the operator, a defroster blowout port (DEF) 7 having an opening directed toward the windshield 9 and a rear blowout port (REAR) 8 having an opening directed upward from the rear of the seat 2, are arranged in the operator cab 100. In this structure, the face blowout port 6 and the rear blowout port 8 function as an air conditioning unit for the upper half of the operator's body which blows out conditioned air to the upper half of the operator's body. The face blowout port 6 and the defroster blowout port 7 are connected to the air conditioner 1 through a front duct 10. In the same manner, the rear blowout port 8 is connected to the air conditioner 1 through a rear duct 11. Air heated or cooled by the air conditioner 1 is sent out from each blowout port arranged in the operator cab 100, so that the temperature in the operator cab 100 can be adjusted or the windshield 9 can be defogged.

The windshield 9 provided on the front of the operator cab can be slid in the vertical direction along rails 12 arranged on both sides of the windshield 9. When the operator lifts the windshield 9, the operator cab can be opened. An open/close sensor 57 is attached to one of the rails 12. The open/close sensor 57 detects whether or not the windshield 9 is opened. Further, the door 13 is arranged on the side of the operator cab 100, and then the operator can get into and off the operator cab through the door 13. The door 13 can rotate around the front side end of the door 13 as a rotary shaft in order to open or close. In a frame portion of the operator cab coming into contact with the door 13 when the door 13 is closed, an open/close sensor 58 is arranged. The open/close sensor 58 detects whether or not the door 13 has been opened.

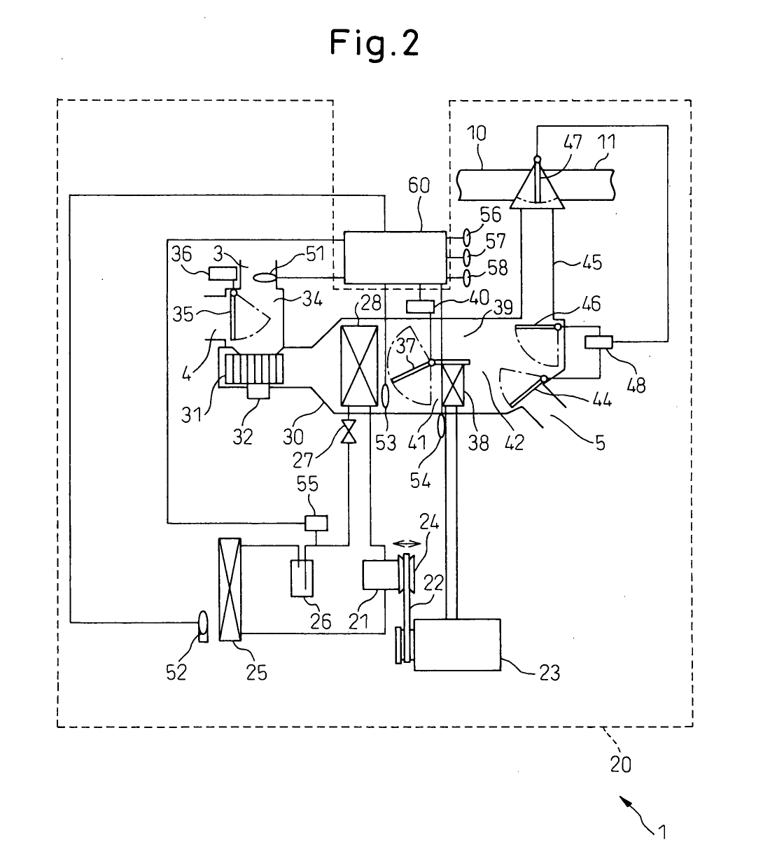

FIG. 2 shows an overall arrangement view of the air conditioner 1. As shown in FIG. 2, the air conditioner 1 comprises: an air conditioning device 20 having a mechanical constitution and a controller 60 for controlling the air conditioning device 20.

First, a constitution of the refrigerating cycle R of the air conditioning device 20 will be explained below. The refrigerating cycle R of the air conditioner 1 is composed of a closed cycle. The closed cycle includes a compressor 21, a condenser 25, a receiver 26, an expansion valve 27 and an evaporator 28. These components are arranged clockwise in the order of the compressor 21, the condenser 25, the receiver 26, the expansion valve 27 and the evaporator 28. The compressor 21 compresses refrigerant so as to make high pressure gas. The compressor 21 has an electromagnetic clutch 24 which is used for transmitting or shutting off power transmitted from a vehicle engine 23 through a belt 22. The condenser 25 cools and liquidizes refrigerant gas of a high temperature and pressure sent from the compressor 21. The receiver 26 stores the liquidized refrigerant so as to adjust the amount of refrigerant circulating in the refrigerating cycle R. In order to prevent the cooling performance from deteriorating, the receiver 26 removes bubbles contained in the liquidized refrigerant and only the liquidized refrigerant is sent to the expansion valve 27. The expansion valve 27 adiabatically expands the liquidized refrigerant so that the temperature and pressure of the refrigerant can be reduced. After that, the low temperature and pressure refrigerant is sent to the evaporator 28. In the evaporator 28, heat is exchanged between the refrigerant and the air sent to the evaporator 28, so that the air can be cooled.

Next, a constitution inside the air conditioning case 30 of the air conditioning device 20 will be explained below. A blower 31 is arranged on the upstream side of the evaporator 28. The blower 31 is composed of a centrifugal fan and driven by a drive motor 32. An inside and outside air changeover box 34 is arranged on the suction side of the blower 31. An inside and outside air changeover door 35, which is driven by an inside and outside servo motor 36, is arranged in the inside and outside air changeover box 34. The inside and outside air changeover door 35 changes over between the inside air suction port 3 and the outside air suction port 4 and opens and closes the inside air suction port 3 and the outside air suction port 4. Air, which has been taken in through the inside air suction port 3 or the outside air suction port 4, is sent to the evaporator 28 by the blower 31 through the inside and outside air changeover box 34. In this connection, when the rotating speed of the blower 31 is adjusted, the volume of air sent out from the air conditioner 1 can be adjusted.

On the downstream side of the evaporator 28, an air mixing door 37 and a heater core 38 are arranged in this order from the evaporator 28 side. In order to heat air passing through the heater core 38, coolant used for cooling the vehicle engine 23 is supplied to the heater core 38 being circulated. In the air conditioning case 30, a bypass passage 39 is arranged which bypasses the heater core 38. The air mixing door 37 is rotated by a temperature control servo motor 40 so as to adjust a ratio of the volume of hot air, which is sent from the passage 41 passing through the heater core 38, to the volume of cold air passing through the bypass passage 39 so that a temperature of air sent out from each blowout port can be adjusted at a predetermined value.

On the downstream side of an air mixing unit 42 in which cold air passing through the bypass passage 39 and hot air sent from the passage 41 passing through the heater core 38 are mixed with each other, a foot door 44 for opening and closing the foot blowout port 5 and a duct door 46 for opening and closing an entrance of the duct 45, which is connected with the face blowout port 6 and the rear blowout port 8, are arranged. In the duct 45, a front duct 10, which is connected with the face blowout port 6 and the defroster blowout port 7, and a front and rear air distribution adjustment door 47 for adjusting the volume of air flowing to the rear duct 11 connected with the rear blowout port 8 are arranged. The doors 44, 46, 47 are driven by a mode servo motor 48. In this connection, concerning the foot door 44 and the duct door 46, instead of the usual door which is rotated around a shaft of one end of the door, a slide door may be used. Concerning the front and rear air distribution adjusting door 47, a rotary door or a film door may be used. Alternatively, slide doors may be arranged at the entrance of the front duct 10 and the entrance of the rear duct 11, respectively.

Next, various sensors incorporated into the air conditioner 1 will be explained below. An inside air temperature sensor 51 is arranged in an opening portion on the inside air suction port 3 side of the inside and outside air changeover box 34 so as to measure temperature Tᵢ in the operator cab. An outside air temperature sensor 52 is arranged in the periphery of the operator cab so as to measure the temperature Tₒ outside the operator cab. In this connection, the outside air temperature sensor 52 may be arranged on the front face of the condenser 25. In order to measure the temperature of air blown out from the evaporator 28, that is, in order to measure the evaporator blowout temperature Tₑ, an evaporator outlet temperature sensor 53 is arranged in the periphery of the blowout port of the air passage on air mixing door 37 side of the evaporator 28. In the periphery of the inlet of the engine coolant to the heater core 38, a heater inlet temperature sensor 54 for measuring the coolant temperature T_{w} is arranged.

A pressure sensor 55 for measuring the pressure P of the refrigerant, which circulates in the refrigerating cycle R, is attached in the periphery of the blowout port of the receiver 26. Further, in order to measure the intensity L of sunlight shining in the operator cab, a sunlight sensor 56 is attached to the periphery of the windshield of the operator cab. In this connection, the sunlight sensor 56 is composed of an illuminance sensor.

As described above, the open/close sensors 57 and 58 are arranged so that opening and closing of the windshield 9 and the door 13 can be detected. The open/close sensor 57 sends an open/close signal S_{f} of the windshield 9 to the controller 60. On the other hand, in the case where the windshield 9 is opened, the controller 60 acquires the open/close signal S_{f} as 1 bit signal having the value “1”. In the case where the windshield 9 is closed, the controller 60 acquires the open/close signal S_{f} as 1 bit signal having the value “0”. In the same manner, the open/close sensor 58 sends an open/close signal S_{d} of the door 13 to the controller 60. On the other hand, in the case where the door 13 is opened, the controller 60 acquires the open/close signal S_{d} as 1 bit signal having the value “1”. In the case where the door 13 is closed, the controller 60 acquires the open/close signal S_{d} as 1 bit signal having the value “0”. In this connection, the open/close sensors 57 and 58 can comprise well known various sensors for detecting a contact or proximity of an object such as a mechanical type contact sensor or an optical type proximity sensor. The open/close sensors 57 and 58 can detect as to whether or not the windshield 9 or the door 13 is closed, by detecting that the windshield 9 or the door 13 comes into contact or comes close to a predetermined range from the sensors.

The sensors 51 to 58 described above are connected to the controller 60. A measurement value acquired by each sensor is sent to the controller 60. The controller 60 controls the electromagnetic clutch 24 according to the measurement values and the operation signal acquired by A/C operation panel (not shown) so as to turn on and off the compressor 21. Further, the controller 60 controls a rotating speed of the blower 31 by controlling the drive motor 32. Furthermore, the controller 60 controls an inside and outside air servo motor 36, a temperature control servo motor 40 and a mode servo motor 48 so as to adjust a degree of opening of each door. When the controller 60 controls them as described above, the temperature and volume of air of the hot air or the cold air blown out from each blowout port are adjusted so that a temperature in the operator cab can become close to the setting temperature which has been set by the operator.

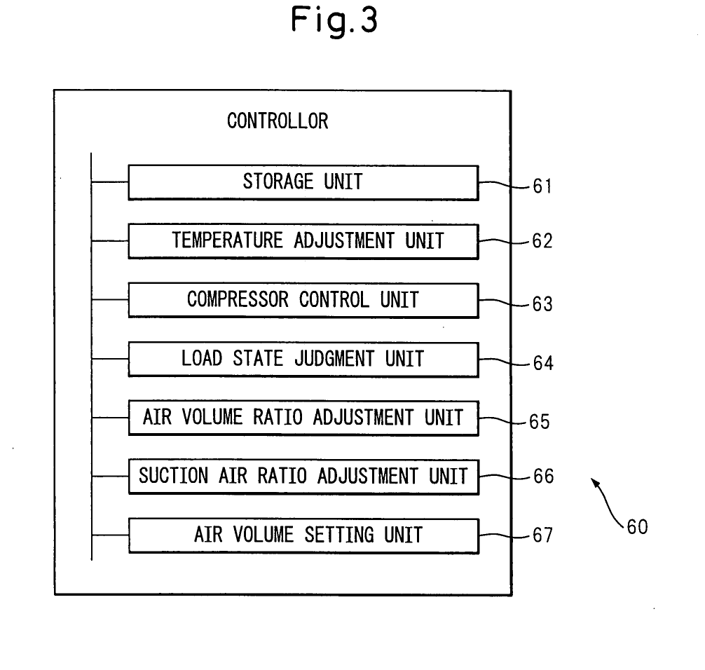

FIG. 3 shows a functional block diagram of the controller 60 of the air conditioner 1.

The controller 60 comprises: one or a plurality of microcomputers composed of a CUP, ROM and RAM not shown in the drawing; peripheral circuits of the microcomputers; and a storage unit 61 such as a nonvolatile memory which can be electrically rewritten.

The controller 60 further comprises: a temperature adjustment unit 62; a compressor control unit 63; a load state judgment unit 64; an air volume ratio adjustment unit 65; a suction air ratio adjustment unit 66; and an air volume setting unit 67, wherein these units are functional modules which are implemented by the microcomputer and by a computer program executed in the microcomputer. These units will be explained below.

The temperature adjustment unit 62 determines the degrees of the openings of the air mixing door 37, based on the setting temperature Tₛ acquired from the A/C operation panel and measurement signals of the temperature sensors 51 to 53, the coolant temperature sensor 54 and the sunlight sensor 56. The temperature adjustment unit 62 sends a control signal to the temperature adjustment servo motor 40 so that the degree of opening of the air mixing door 37 can be a setting position. For example, the temperature adjustment unit 62 decides the degree of opening of the air mixing door 37 according to a relational equation, the output of which is the degree of opening of the air mixing door 37, when a value, which is obtained when a difference between the inside air temperature Tᵢ and the setting temperature Tₛ is corrected by the outside temperature Tₒ and the quantity of sunlight L, is used as an input. In this case, the temperature adjustment unit 62 can stably control the air mixing door 37 by determining the degree of opening of the air mixing door 37 at certain time intervals (for example, for each second) using each measurement value obtained in the past. A relational equation between each measurement value and the degree of opening of the air mixing door 37 is shown as follows.

$${Y}_{n} = α {\sum }_{j = 1}^{n - 1} [ {Ti}_{j} - ( {Ts}_{j} + β {To}_{j} + γ {L}_{j} ) ] + {Ti}_{n} - ( {Ts}_{n} + β {To}_{n} + γ {L}_{n} )$$

$$Do = {aY}_{n} + b$$

In the above equation, Dₒ represents a degree of opening of the air mixing door 37. Coefficients α, β, γ, a and b are constants. Tₛⱼ, Tᵢⱼ, Tₒⱼ, Lⱼ (j=1, 2, . . . , n) respectively represent a setting temperature, inside air temperature, outside air temperature and a quantity of sunlight at the point of time of the measurement made by J times. However, the degree of the opening Dₒ of the air mixing door 37 is set in such a manner that the degree of opening Dₒ of the air mixing door 37 is 100% when the passage 41 passing through the heater core 38 is closed, that is, only when the cooling operation is conducted and that the degree of the opening Dₒ of the air mixing door 37 is 0% when the bypass passage 39 is closed, that is, only heating operation is conducted.

In this connection, the temperature adjustment unit 62 may decide the air conditioning temperature and the degree of opening of the air mixing door 37 by another well known control method. The calculated degree of opening of the air mixing door 37 is stored in the storage unit 61 so that the degree of opening can be referred in the other unit of the controller 60.

The load state judgment unit 64 judges whether the load state of the air conditioner 1 corresponds to a cooling operation or a heating operation, based on the setting temperature Tₛ acquired from the A/C operation panel and the measurement signals acquired from the temperature sensors 51 to 53.

For example, in the case where the setting temperature Tₛ is higher than the inside air temperature Tᵢ, the load state judgment unit 64 judges that it is a heating load. On the contrary, in the case where the inside air temperature Tᵢ is not less than the setting temperature Tₛ, the load state judgment unit 64 judges that it is a cooling load. Alternatively, the load state judgment unit 64 may judge whether or not it is the heating load based on the degree of opening of the air mixing door 37 determined by the above temperature adjustment unit 62. For example, in the case where the degree of opening of the air mixing door 37 is set in such a manner that the passage 41 on the heater core 38 is wider than the bypass passage 39, the load state judgment unit 64 judges that it is the heating load. In the case where the degree of opening of the air mixing door 37 is set in such a manner that the passage 41 on the heater core 38 is narrower than the bypass passage 39, the load state judgment unit 64 judges that it is a cooling load.

In the case where the setting of heating and/or cooling is manually set by an operator, the load state judgment unit 64 judges whether or not it is a heating load by referring to a heating/cooling changeover signal sent from A/C operation panel.

For example, the result of judgment is prescribed as a binary variable of 1 bit and stored in the storage section 61 so that it can be referred by the other unit in the controller 60.

The compressor control unit 63 controls the compressor 21 so as to turn on and off the compressor 21 based on the evaporator outlet temperature Tₑ and the load state of the air conditioner 1, which is judged by the load state judgment unit 64. For example, in the case where the result of judgment made by the load state judgment unit 64 is the cooling load, the compressor control unit 63 turns on the compressor 21 in principle. In this connection, when a temperature of the evaporator 28 is decreased to a value not more than 0° C., the evaporator 28 is frosted over. When the evaporator 28 is frosted over, frost is generated among the fins of the evaporator 28. Therefore, it becomes very difficult for air to flow among the fins. Accordingly, it is impossible for the evaporator 28 to sufficiently exchange heat. In order to prevent the evaporator 28 from being frosted over, when the evaporator outlet temperature Tₑ is decreased to the frost limit temperature T_{f}, the compressor control unit 63 stops the compressor 21, that is, the compressor control unit 63 disconnects the electromagnetic clutch 24 so that power can not be transmitted from the vehicle engine 23 to the compressor 21. For example, the frost limit temperature T_{f} is set at about 1° C. On the other hand, in the case where the evaporator outlet temperature Tₑ is higher than the frost limit temperature T_{f}, the compressor control unit 63 makes the compressor 21 continue to operate.

After the compressor 21 has stopped, the compressor control unit 63 restarts the compressor 21 when the temperature of the evaporator 28 has somewhat increased, that is, the compressor control unit 63 connects the electromagnetic clutch 24 so that power can be transmitted from the vehicle engine 23 to the compressor 21. Therefore, the compressor operation starting temperature Tₒₙ, at which the compressor 21 restarts, is set at a temperature higher than a threshold value temperature, at which the compressor 21 is stopped, by a predetermined value. For example, the compressor operation starting temperature Tₒₙ can be set 5° C. higher than the frost limit temperature T_{f}. The compressor control unit 63 compares the evaporator outlet temperature Tₑ with the compressor operation starting temperature Tₒₙ. In the case where the evaporator outlet temperature Tₑ exceeds the compressor operation starting temperature Tₒₙ, the compressor control unit 63 makes the compressor 21 restart.

In the case where the load state judged by the load state judgment unit 64 is a heating load, the compressor control unit 63 stops the compressor 21 in principle. However, in the case where an operation signal to operate the defroster is received from the A/C control panel, the compressor control unit 63 makes the compressor 21 operate in order to defrost the windshield 9.

The air volume ratio adjustment unit 65 determines a ratio of air volume of the conditioned air blown out from each blowout port based on the result of judgment by the load state judgment unit 64, the open/close signal S_{f} of the windshield 9 acquired from the open/close sensor 57 and the open/close signal S_{d} of the door 13 acquired from the open/close sensor 58. Further, the air volume ratio adjustment unit 65 determines degrees of opening of the foot door 44, the duct door 46 and the front and rear air distribution adjusting door 47 so that the degrees correspond to the air volume ratio. The air volume ratio adjustment unit 65 controls the mode servo motor 48 so that each door has the determined degree of opening.

For example, in the case where the load state of the air conditioner 1 is a heating load and both the windshield 9 and the door 13 are closed (S_{f}=0 and S_{d}=0, that is, the operator cab is closed), the air volume ratio adjustment unit 65 opens only the foot door 44 and closes the duct door 46 so that the conditioned air can be blown out from only the foot blowout port 5. On the other hand, in the case where it is detected that the windshield 9 is opened (S_{f}=1) or the door 13 is opened (S_{d}=1), that is, in the case where it is detected that the operator cab is opened, the air volume ratio adjustment unit 65 opens both the duct door 46 and the foot door 44 so that the conditioned air can be blown out from the face blowout port 6, the rear blowout port 8 and the foot blowout port 5.

For example, in the case where the load state of the air conditioner 1 is a cooling load, the air volume ratio adjustment unit 65 closes the foot door 44 and opens the duct door 46 so that the conditioned air can be blown out from the face blowout port 6 and the rear blowout port 8. When it is detected that the operator cab is opened, the air volume ratio adjustment unit 65 adjusts a degree of opening of the front and rear air distribution adjusting door 47 so that the ratio of volume of the conditioned air blown out from the face blowout port 6 can be increased as compared with the case in which the operator cab is closed.

In this connection, the air volume ratio adjustment unit 65 may adjust the air volume ratio by referring to the inside air temperature Tᵢ acquired from the inside air temperature sensor 51 and the outside air temperature Tₒ acquired from the outside air temperature sensor 52. According to this embodiment, in the case where the load state of the air conditioner 1 is a heating load, the condition for increasing the ratio of volume of the conditioned air blown out from the face blowout port 6 is that the windshield 9 or the door 13 is opened, and the outside air temperature Tₒ is not more than 0° C. In this connection, the air volume ratio adjustment unit 65 may increase the ratio of the air volume blown out from the face blowout port 6 in accordance with a decrease in the inside air temperature Tᵢ. The relationship between the open/close signals S_{d}, S_{f}, the outside air temperature Tₒ and the degree of the opening of the duct door 46 and the relationship between S_{d}, S_{f}, Tₒ, and the degree of the opening of the front and rear air distribution adjusting door 47 are determined by a lookup table. The lookup table is previously prepared and stored in the storage unit 61. When the open/close signals S_{d}, S_{f} and the outside temperature Tₒ are acquired, the air volume ratio adjustment unit 65 refers to the lookup table and decides the degrees of opening of the duct door 46 and the front and rear air distribution adjusting door 47.

The suction air ratio adjustment unit 66 sets a ratio of the air, which is sucked from the inside air suction port 3 by the air conditioner 1, to the air, which is sucked from the outside air suction port 4, based on the inside air temperature Tᵢ, the suction setting, and the setting temperature Tₛ acquired from the A/C operation panel. The suction air ratio adjustment unit 66 determines a degree of opening of the inside and outside air changeover door 35 based on a relational equation which represents a relation of the difference between the inside air temperature Tᵢ and the setting temperature Tₛ with the suction air ratio. This relational equation is previously set and incorporated into a computer program executed by the controller 60. In this connection, the suction air ratio adjustment unit 66 can determine the degree of opening of the inside and outside air changeover door 35 using another well known method. The suction air ratio adjustment unit 66 controls the inside and outside air servo motor 36 and rotates the inside and outside air changeover door 35 so that the suction air ratio can be the determined value.

The air volume setting unit 67 determines a rotating speed of the blower 31 based on the setting temperature and the air volume setting value acquired from the A/C operation panel, and the measurement signals acquired from the temperature sensors 51 to 53 and the sunlight sensor 56. The air volume setting unit 67 sends a control signal to the drive motor 32 so that the rotating speed of the blower 31 can be the determined value. For example, in the case where the air volume is manually set, the air volume setting unit 67 decides a rotating speed of the blower 31 so that the air volume can be the air volume setting value acquired from the A/C operation panel. In the case where the air volume is automatically set, the air volume setting unit 67 decides a rotating speed of the blower 31 according to a relational equation which represents a relation between the inside air temperature and the air volume or a relation between a difference of the inside air temperature and the setting temperature, and the air volume. This relational equation is previously set and incorporated into a computer program executed by the controller 60. In this connection, the air volume setting unit 67 can decide a rotating speed of the blower 31 using another well known method.

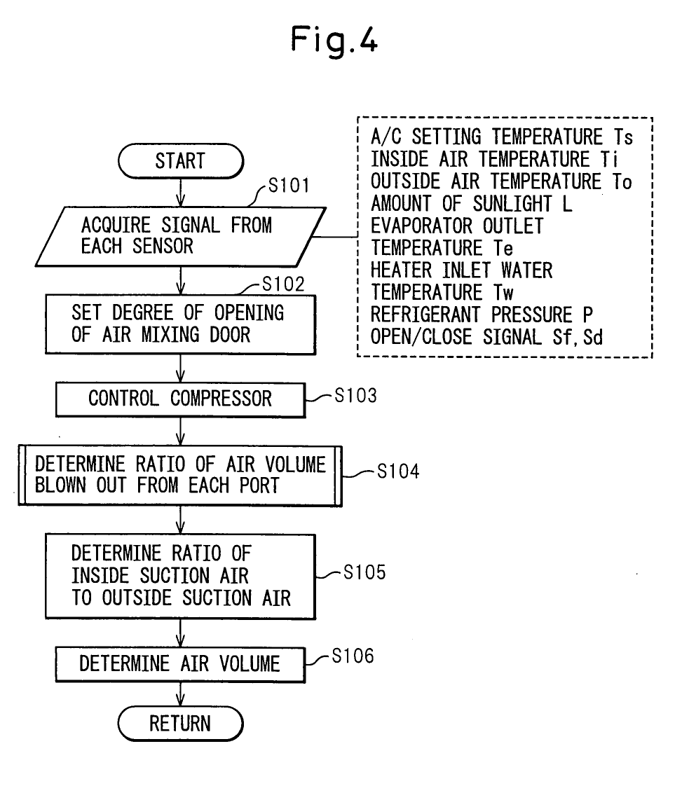

Referring to the flow chart shown in FIG. 4, the air conditioning control operation of the air conditioner 1 according to the present invention, will be explained below. In this connection, the controller 60 controls the air conditioning device 20 by the computer program incorporated into the controller 60.

As shown in FIG. 4, first of all, when the controller 60 receives a signal to operate the air conditioner 1 from the A/C operation panel, the controller 60 makes the air conditioner 1 start. The controller 60 acquires a measurement signal from each sensor (step S101). Next, the temperature adjustment unit 62 of the controller 60 determines the degree of opening of the air mixing door 37 so that the temperature of the conditioned air blown out from each blowout port is a predetermined temperature based on the signal of each sensor and the setting temperature, which is acquired from the A/C operation panel (step S102). Then, the temperature adjustment unit 62 drives the temperature adjusting servo motor 40 and rotates the air mixing door 37 so that the degree of opening of the air mixing door 37 is determined.

Next, the compressor control unit 63 of the controller 60 turns on or off the compressor 21 based on the load state of the air conditioner 1 judged by the load state judgment unit 64 and whether or not defogging is to be performed (step S103). Alternatively, the compressor control unit 63 may turn on or off the compressor 21 based on the temperature of the evaporator 28.

After that, the air volume ratio adjustment unit 65 of the controller 60 determines the air volume ratio of volume of the conditioned air blown out from each blowout port (step S104). In this connection, the decision of the air volume ratio will be described in detail later.

After the air volume ratio has been determined, the suction air ratio adjustment unit 66 of the controller 60 sets a suction ratio of the air, which is sucked from the operator cab, to the air which is sucked from the outside of the operator cab (step S105). The suction air ratio adjustment unit 66 controls the inside and outside air servo motor 36 and rotates the inside and outside air changeover door 35 so that the door 35 is opened by the degree of opening of the door 35 corresponding to the suction ratio.

Finally, the air volume setting unit 67 of the controller 60 sets an air volume blown out from the air conditioner 1 (step S106). Then, the air volume setting unit 67 decides a rotating speed of the blower 31 based on the air volume. After that, the controller 60 repeats the control of steps S101 to S106 at predetermined time intervals until operation of the air conditioner 1 is stopped.

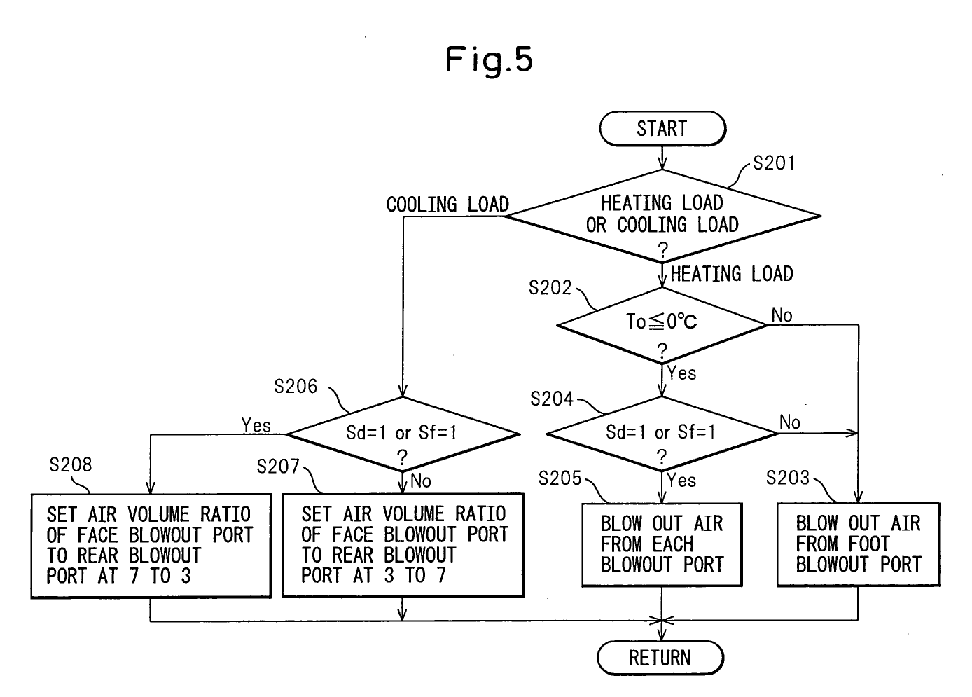

FIG. 5 is a flow chart in which the process for determining the air volume ratio at step S104 of FIG. 4 is shown in detail.

As shown in FIG. 5, first, the load state judgment unit 64 judges whether the load state of the air conditioner 1 is a heating load or a cooling load (step S201). In the case where it is judged that the load state of the air conditioner 1 is a heating load, the air volume ratio adjustment unit 65 of the controller 60 judges whether or not the outside air temperature Tₒ is higher than 0° C. (step S202). In the case where the outside air temperature Tₒ is higher than 0° C. in step S202, the air volume ratio adjustment unit 65 closes the duct door 46 so that hot conditioned air can be blown out only from the foot blowout port 5 (step S203). On the other hand, in the case where it is judged at step S202 that the outside air temperature Tₒ is less or equal 0° C., the air volume ratio adjustment unit 65 judges whether or not the windshield 9 or the door 13 is opened based on the open/close signal S_{f} of the windshield 9 and the open/close signal S_{d} of the door 13 (step S204).

In the case where S_{d}=0 and S_{f}=0 at step S204, that is, in the case where both the windshield 9 and the door 13 are closed, the air volume ratio adjustment unit 65 closes the duct door 46 so that hot conditioned air can be blown out only from the foot blowout port 5 as described above (step S203). On the other hand, in the case where S_{d}=1 or S_{f}=1 at step S204, that is, in the case where either the windshield 9 or the door 13 is opened, the air volume ratio adjustment unit 65 opens the duct door 46 so that hot conditioned air can be blown out from the face blowout port 6, the rear blowout port 8 and the foot blowout port 5 (step S205). In this case, the air volume ratio adjustment unit 65 sets a ratio of the air volume blown out from the face blowout port 6 to the air volume blown out from the rear blowout port 8 to be 1 to 1.

At step 201, in the case where the load state judgment unit 64 judges that the load state of the air conditioner 1 is the cooling load, the air volume ratio adjustment unit 65 judges whether or not the windshield 9 or the door 13 is opened based on the open/close signal S_{f} of the windshield 9 and the open/close signal S_{d} of the door 13 (step S206).

In the case where S_{d}=0 and S_{f}=0 at step S206, that is, in the case where both the windshield 9 and the door 13 are closed, the air volume ratio adjustment unit 65 opens the duct door 46 and closes the foot door 44 so that cold conditioned air can be blown out from the face blowout port 6 and the rear blowout port 8. Further, the air volume ratio adjustment unit 65 rotates the front and rear air distribution adjusting door 47 so that the ratio of the volume of air blown out from the face blowout port 6 to the volume of air blown out from the rear blowout port 8 is 3 to 7 (step S207). On the other hand, in the case where S_{d}=1 or S_{f}=1 at step S206, that is, in the case where either the windshield 9 or the door 13 is opened, the air volume ratio adjustment unit 65 closes the foot door 44 and opens the duct door 46 in the same manner. Further, the air volume ratio adjustment unit 65 rotates the front and rear air distribution adjusting door 47 so that the ratio of the volume of air blown out from the face blowout port 6 to the volume of air blown out from the rear blowout port 8 is 7 to 3, so as to increase a volume of cold conditioned air blown out from the face blowout port 6 (step S208).

As described above, according to the air conditioner of one embodiment of the present invention, when it is detected that the windshield of the operator cab is opened, a ratio of the volume of the conditioned air blown out to the upper half of the operator's body, especially, a ratio of the volume of the conditioned air blown out from the front blowout port to the front face of the operator, is increased. Therefore, the conditioned air can be supplied to and concentrated on the periphery of the operator. Accordingly, the air conditioner can effectively condition air in the operator cab, and thus, even if the windshield or the door of the operator cab is opened, the operator can comfortably work in the operator cab.

It should be noted that the present invention is not limited to the above specific embodiment. For example, a ratio of volume of the conditioned air blown out from each blowout port can be variously set according to the structure of the operator cab. For example, at steps S205 and S208 described above, the air volume ratio adjustment unit 65 may rotate the front and rear air distribution adjusting door 47 so that the ratio of the volume of air blown out from the face blowout port 6 to the volume of air blown out from the rear blowout port 8 is 10 to 0. In the case of a heating load, even if the operator cab is closed (at step 203), the air volume ratio adjustment unit 65 may control the duct door 46 so that the conditioned air is also blown out from the face blowout port 6 and the rear blowout port 8. Further, in the case where the operator cab is opened, the air volume ratio adjustment unit 65 may set the ratio of the air volume of the conditioned air blown out from the face blowout port 6 to the air volume of the conditioned air blown out from the rear blowout port 8 so that the air volume blown out from the face blowout port 6 is larger than the air volume blown out from the rear blowout port 8.

In the embodiment described above, the controller 60 refers to the outside air temperature Tₒ in order to determine the ratio of the volume of the conditioned air blown out from each blowout port, only in the case of a heating load. However, in the case of a cooling load, the controller 60 may refer to the outside air temperature Tₒ or the inside air temperature Tᵢ in order to determine the ratio. In this case, only when the operator cab is opened and the outside air temperature Tₒ or the inside air temperature Tᵢ is not less than 30° C., the controller 60 may determine the ratio of the volume of the conditioned air blown out from the face blowout port 6 to be increased. Further, the controller 60 may refer to an amount of the sunlight L instead of the outside air temperature Tₒ or the inside air temperature Tᵢ. Alternatively, the controller 60 may refer to an amount of sunlight L together with the outside air temperature Tₒ or inside air temperature Tᵢ. For example, in the case where an amount of sunlight L exceeds 800 W/m², the controller 60 may reduce a volume of air blown out from the foot blowout port 5 and increase volumes of air blown out from the face blowout port 6 and the rear blowout port 8.

Further, when the operator opens the door 13 and gets into the operator cab, in order to avoid feeling too hot or too cold, it is preferable that a volume of air blown out from the face blowout port 6 is not increased. Therefore, when the controller 60 continuously receives a signal (S_{d}=1), which indicates that the door 13 has been opened, from the open/close sensor 58, for a predetermined period of time (for example, for 2 minutes), the air volume ratio adjustment unit 65 may control the mode servo motor 48 so that the volume of air blown out from the face blowout port 6 is increased.

In addition to the constitution of the present invention, when the operator cab is opened, the temperature adjustment unit 62 may control the compressor 21 so that a rotating speed of the compressor 21 is increased in order to enhance air conditioning power. The temperature adjustment unit 62 may also control the air mixing door 37 to change the degree of opening thereof. Further, when the operator cab is opened, the air volume setting unit 67 may control the blower 31 so that the rotating speed of the blower 31 is increased in order to increase the volume of air blown out from each blowout port.

Further, the air conditioning unit, which enhances the air conditioning power for the upper half of the operator body when the operator cab is opened, is not limited to the above specific embodiment. For example, a well known heater for heating the upper half of the operator's body may be attached to a pillar on the side of the operator cab. Only when the operator cab is opened, can the controller 60 operate the heater.

As described above, variations can be made within the scope of claim of the present invention.

What is claimed is:

1. An air conditioner for conditioning air in an operator cab of a vehicle, comprising:
a heating unit for heating an upper half of an operator's body;
an open/close sensor for detecting whether said operator cab is opened or closed; and
a controller for setting a heating power of said heating unit when said open/close sensor detects that said operator cab is opened, to be higher than the heating power of said heating unit when the operator cab is closed.

2. An air conditioner according to claim 1, wherein
said heating unit comprises a front face heating unit for heating a front face of the operator, and
said controller sets a heating power of
said front face heating unit to be higher than the heating power of said front face heating unit when the operator cab is closed, in the case where said open/close sensor detects that said operator cab is opened.

3. An air conditioner according to claim 1, wherein said vehicle is a construction vehicle.

4. An air conditioner for conditioning air in an operator cab of a vehicle, comprising:
an air conditioning unit for generating conditioned air;
at least one first blowout port for blowing out the conditioned air to an upper half of an operator's body;
a second blowout port for blowing out the conditioned air;
an open/close sensor for detecting whether said operator cab is opened or closed; and
a controller for setting a ratio of volume of the conditioned air, which is blown out from said at least one first blowout port, in the conditioned air, which is blown out from each blowout port when said open/close sensor detects that said operator cab is opened, to be higher than the ratio of volume of the conditioned air when said operator cab is closed.

5. An air conditioner according to claim 4, wherein the conditioned air is heated.

6. An air conditioner according to claim 4, wherein
said at least one first blowout port comprises a face blowout port for blowing out the conditioned air to the front face of the operator, and
said controller sets the ratio of volume of the conditioned air, which is blown out from said face blowout port, in the conditioned air, which is blown out from each blowout port, so that the ratio of volume of the conditioned air when said open/close sensor detects that said operator cab is opened, is higher than the ratio of volume of the conditioned air when said operator cab is closed.

7. An air conditioner according to claim 4, wherein
said second blowout port is a blowout port arranged in a lower portion of a operator's seat, and
said controller sets the ratio of volume of the conditioned air so that, when said open/close sensor detects that said operator cab is opened, the conditioned air is blown out from both said at least one first blowout port and said second blowout port, and when said open/close sensor detects that said operator cab is closed, the conditioned air is only blown out from said second blowout port.

8. An air conditioner according to claim 4, further comprising:
a temperature sensor for measuring a temperature of air in said operator cab or a temperature of air out said operator cab, wherein
said controller sets the ratio of volume of the conditioned air when said open/close sensor detects that said operator cab is opened and the measured temperature of the outside air or the inside air is not higher than a predetermined temperature, to be higher than the ratio of volume of the conditioned air when said operator cab is closed.

9. An air conditioner according to claim 4, wherein said vehicle is a construction vehicle.

10. A method of controlling an air conditioner for conditioning air in an operator cab in a vehicle, the air conditioner comprising a heating unit for heating an upper half of an operator's body in said operator cab, comprising:
detecting whether said operator cab is opened or closed; and
setting a heating power of said heating unit when it is detected that said operator cab is opened, to be higher than the heating power of said heating unit when said operator cab is closed.

11. A method of controlling an air conditioner for conditioning air in an operator cab of a vehicle, the air conditioner comprising an air conditioning unit for generating conditioned air, at least one first blowout port for blowing out the conditioned air to an upper half of an operator's body and a second blowout port for blowing out the conditioned air,
the method comprising:
detecting whether said operator cab is opened or closed; and
setting a ratio of volume of the conditioned air, which is blown out from said first blowout port, in the conditioned air which is blown out from each blowout port, so that the ratio of volume of the conditioned air when it is detected that said operator cab is opened, is higher than the ratio of volume of the conditioned air when it is detected that said operator cab is closed.
